(19) United States
(12) Patent Application Publication
(10) Pub. No.: US 2015/0162643 A1
(43) Pub. Date: Jun. 11, 2015

(54) ALL-SOLID BATTERY

(71) Applicant: Murata Manufacturing Co., Ltd., Nagaokakyo-shi (JP)

(72) Inventors: Mika TAGAMI, Nagaokakyo-shi (JP); Tadaaki MATSUMURA, Nagaokakyo-shi (JP); Miai TAINAKA, Nagaokakyo-shi (JP)

(21) Appl. No.: 14/627,582

(22) Filed: Feb. 20, 2015

Related U.S. Application Data
(63) Continuation of application No. PCT/JP2013/070973, filed on Aug. 2, 2013.

(30) Foreign Application Priority Data
Aug. 21, 2012 (JP) 2012-182521

(51) Int. Cl. H01M 10/0562; H01M 4/136; H01M 10/0525; H01M 4/58; H01M 4/62; H01M 4/133; H01M 4/583

(52) U.S. Cl. CPC H01M 10/0562; H01M 4/133; H01M 4/136; H01M 4/583; H01M 4/58; H01M 4/62; H01M 10/0525; H01M 2220/30

(57) ABSTRACT

An all-solid battery laminate which includes a positive electrode layer, a negative electrode layer and a solid electrolyte layer interposed between the positive electrode layer and the negative electrode layer. The negative electrode layer contains a negative electrode active material and a solid electrolyte, and an area ratio of the negative electrode active material is 72% or less in a surface of the negative electrode layer opposite to the solid electrolyte-side surface of the negative electrode layer.

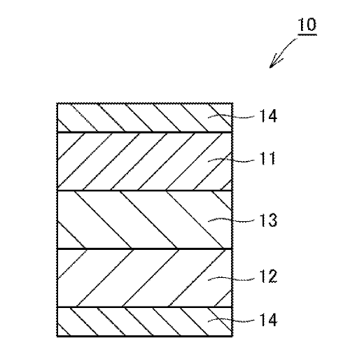

### CROSS REFERENCE TO RELATED APPLICATIONS

The present application is a continuation of International application No. PCT/JP2013/070973, filed Aug. 2, 2013, which claims priority to Japanese Patent Application No. 2012-182521, filed Aug. 21, 2012, the entire contents of each of which are incorporated herein by reference.

### FIELD OF THE INVENTION

The present invention relates to an all-solid battery.

### BACKGROUND OF THE INVENTION

In recent years, along with the development of portable electronic devices such as mobile phones and notebook computers, the demand for secondary batteries as built-in batteries of these electronic devices has been increasing. In particular, the development of lithium ion secondary batteries which have a high energy density and are capable of being charged/discharged has been extensively conducted.

Power consumption of portable electronic devices has been remarkably increasing as the number of their functions has been increased. For coping with the increase in power consumption, lithium ion secondary batteries having a large capacity have been required.

In the lithium ion secondary battery, in general, a metal oxide such as lithium cobaltate is used as a positive electrode active material, a carbon material such as graphite is used as a negative electrode active material, and a solution obtained by dissolving lithium hexafluorophosphate in an organic solvent, i.e. an organic solvent-based electrolytic solution is used as an electrolyte. In a battery having the above-mentioned configuration, an attempt has been made to increase internal energy by increasing the amount of an active material, and further, enhance the energy density, so that the output current is improved. It is also expected that the battery is increased in size and that the battery is mounted on a vehicle.

However, in a lithium ion secondary battery having the above-described configuration, an organic solvent used for the electrolyte is a combustible material, and therefore there is the risk that the battery may catch fire. For this reason, it is required that safety of the battery be further enhanced.

One of measures for enhancing safety of the lithium ion secondary battery is to use a solid electrolyte in place of an organic solvent-based electrolytic solution. As the solid electrolyte, use of organic materials such as polymers and gels and inorganic materials such as glass and ceramic is being studied. In particular, an all-solid secondary battery including as a solid electrolyte an inorganic material having incombustible glass or ceramic as a main component has been proposed, and is attracting attention.

For examples, JP 2011-28893 A (hereinafter, referred to as Patent Document 1) describes an all-solid battery which has a positive electrode active material layer containing a positive electrode active material, a negative electrode active material layer containing a negative electrode active material, and a solid electrolyte layer formed between the positive electrode active material layer and the negative electrode active material layer. Patent Document 1 describes that a ratio of a sulfide solid electrolyte material contained in the negative electrode active material layer of the above all-solid battery is preferably particularly within the range of 10% by volume to 50% by volume. It is described in Patent Document 1 that carbon is used as a negative electrode active material.

Further, for examples, JP 2008-288098 A (hereinafter, referred to as Patent Document 2) describes an all-solid battery in which a formed body of a sulfide-based solid electrolyte is supported by sandwiching it between a pair of electrodes consisting of a positive electrode and a negative electrode. Patent Document 2 describes that a mixing ratio (weight ratio) of a powder of the sulfide-based solid electrolyte and the negative electrode active material respectively contained in the negative electrode of the above all-solid battery is preferably 20 to 50:80 to 50. It is also described that a carbon material is used as a negative electrode active material.

Patent Document 1: JP 2011-28893 A

Patent Document 2: JP 2008-288098 A

### SUMMARY OF THE INVENTION

In a configuration of an all-solid battery, a local reaction takes place, resulting in deterioration of charge-discharge efficiency. The local reaction refers to a reaction in which an insertion/desorption reaction of lithium ions that normally proceeds over the whole of an electrode layer (active material layer) uniformly proceeds over only a part of the electrode layer.

When the local reaction takes place in the electrode layer, absorption of lithium ions is concentrated on an active material at a specific location, so that the utilization rate of the active material is reduced. Further, in a negative electrode layer containing carbon as an active material, when the charge rate is increased, local overcharge occurs, so that a lithium metal is precipitated. When the precipitated lithium metal grows along a direction perpendicular to the lamination direction and arrives at a positive electrode layer, the battery is short-circuited, leading to occurrence of voltage reduction.

In the all-solid battery using a sulfide as the solid electrolyte, when a carbon material is used as the negative electrode active material, there is a problem that failure during charge due to precipitation of lithium metal easily occurs and charge-discharge efficiency is reduced. In order to prevent the precipitation of lithium metal, it is necessary to appropriately control the electron conduction and ion conduction within a negative electrode layer.

In the constitution of the all-solid batteries described in Patent Documents 1 and 2, a ratio of the solid electrolyte contained in the negative electrode layer is specified; however, it is not enough for appropriately controlling the electron conduction and ion conduction within a negative electrode layer only by controlling a volume ratio or a weight ratio of the solid electrolyte, and therefore the above-mentioned problem of a reduction in charge-discharge efficiency cannot be solved.

Thus, it is an object of the present invention to provide an all-solid battery which is capable of improving charge-discharge efficiency by appropriately controlling the electron conduction and ion conduction within a negative electrode layer.

The present inventors made various investigations concerning the constitution of an all-solid battery, and consequently they found that in order to appropriately control the electron conduction and ion conduction within a negative electrode layer, it is necessary not only to control a mixing ratio between the negative electrode active material and the solid electrolyte within the negative electrode layer but also to control a mixing state or a dispersion state of the negative electrode active material and the solid electrolyte within the negative electrode layer. That is, the present inventors found that when the area ratio of the negative electrode active material is controlled in a surface opposite to the surface adjacent to the solid electrolyte layer of the negative electrode layer (that is, the surface adjacent to the current collector layer of the negative electrode layer), failure during charge due to precipitation of lithium metal hardly occurs, and a reduction in charge-discharge efficiency can be suppressed. Based on this finding, the all-solid battery according to the present invention includes the following characteristics.

The all-solid battery according to the present invention comprises a positive electrode layer, a negative electrode layer and a solid electrolyte layer interposed between the positive electrode layer and the negative electrode layer. The negative electrode layer contains a negative electrode active material and a solid electrolyte. The area ratio of the negative electrode active material is 72% or less in a surface of the negative electrode layer, the surface being opposite to the solid electrolyte-side surface of the negative electrode layer.

The negative electrode active material is preferably a carbon material.

Further, the solid electrolyte preferably contains Li₂S and P₂S₅.

Moreover, with respect to the solid electrolyte, a formed body obtained by press forming at a pressure of 365 MPa preferably has a relative density of 0.9 or more.

Negative electrode active material particles constituting the negative electrode layer has a particle size ratio (D10/D90) of 0.5 or more.

In accordance with the present invention, it is possible to attain an all-solid battery having high charge-discharge efficiency by controlling the area ratio of the negative electrode active material in a surface of the negative electrode layer, the surface being opposite to the solid electrolyte-side surface of the negative electrode layer.

### BRIEF EXPLANATION OF THE DRAWING

The Figure is a sectional view schematically showing cross section structures of battery elements of an all-solid battery as an embodiment of the present invention.

### DETAILED DESCRIPTION OF THE INVENTION

Hereinafter, embodiments of the present invention will be described with reference to the drawings.

As shown in the Figure, an all-solid battery laminate 10 as an embodiment, in which a manufacturing method of the present invention is applied, is composed of electric cells including a positive electrode layer 11, a solid electrolyte layer 13, a negative electrode layer 12 and a current collector layer 14. The positive electrode layer 11 is arranged on one surface of the solid electrolyte layer 13, and the negative electrode layer 12 is arranged on the other surface of the solid electrolyte layer 13, the other surface being opposite to the one surface of the solid electrolyte layer 13. In other words, the positive electrode layer 11 and the negative electrode layer 12 are disposed on opposite sides of the solid electrolyte layer 13. A current collector layer 14 is arranged on a surface of the positive electrode layer 11, the surface being not in contact with the solid electrolyte layer 13, and a current collector layer 14 is arranged on a surface of the negative electrode layer 12, the surface being not in contact with the solid electrolyte layer 13. In addition, each of the positive electrode layer 11 and the negative electrode layer 12 contains a solid electrolyte and an electrode active material, and the solid electrolyte layer 13 contains a solid electrolyte.

In the all-solid battery laminate 10 of the present invention configured as described above, the area ratio of the negative electrode active material is 72% or less in a surface opposite to the surface adjacent to the solid electrolyte layer 13 of the negative electrode layer 12 (a surface of the negative electrode layer 12, the surface being opposite to the solid electrolyte-side surface of the negative electrode layer 12).

When the area ratio of the negative electrode active material is controlled so as to be 72% or less in a surface opposite to the surface adjacent to the solid electrolyte layer 13 of the negative electrode layer 12 (that is, the surface of the negative electrode layer 12, the surface being adjacent to the current collector layer 14), failure during charge due to precipitation of lithium metal hardly occurs, and a reduction in charge-discharge efficiency can be suppressed. Thereby, an all-solid battery having high charge-discharge efficiency can be attained.

The above-described configuration and effect of the present invention are based on the findings by the present inventors described below.

During charging, lithium ions moves from the positive electrode layer 11 to the negative electrode layer 12 through the solid electrolyte layer 13, and is absorbed in the negative electrode active material. In an ideal state, lithium ions exiting the positive electrode layer 11 are uniformly absorbed in the whole negative electrode layer 12, but if the state of the negative electrode layer 12 is not appropriate, electrons are excessively supplied to the vicinity of the interface between the solid electrolyte layer 13 and the negative electrode layer 12, and thereby, metallic lithium is precipitated and dendrite of metallic lithium is generated. When the dendrite grows, electrons leak out of the negative electrode layer 12 toward the positive electrode layer 11, and a problem that charge-discharge efficiency (=discharge capacity/charge capacity) is reduced arises.

In order to prevent such a reduction in charge-discharge efficiency, it is necessary to bring the negative electrode layer 12 into an appropriate state. Since the negative electrode layer 12 contains a mixture of the negative electrode active material and the solid electrolyte, conventionally, a method of changing the mixing ratio between the negative electrode active material and the solid electrolyte is employed in order to change the state of the negative electrode layer 12. However, the present inventors made various investigations concerning a constitution of the all-solid battery, and consequently they found that in fact, a problem of a reduction in charge-discharge efficiency cannot be solved only by merely controlling a ratio between the negative electrode active material and the solid electrolyte. Thus, in the present invention, a reduction in charge-discharge efficiency is suppressed by improving a dispersion state of the negative electrode active material noting electron transfer within the negative electrode layer 12, and reducing the area ratio of the negative electrode active material to 72% or less in the vicinity of the interface between the current collector layer 14 and the negative electrode layer 12.

This mechanism can be explained as follows.

When the area ratio of the negative electrode active material is larger than 72% in the vicinity of the interface between the current collector layer 14 and the negative electrode layer 12, the amount of electrons supplied to the negative electrode layer 12 is excessive. The electrons excessively supplied are moved to the vicinity of the interface between the negative electrode layer 12 and the solid electrolyte layer 13 and therefore the vicinity of the interface comes to be excessively charged. Then, when the electrons are further supplied, dendrite of metallic lithium is generated to make a path through which electrons flow from the negative electrode layer 12 to the positive electrode layer 11, and therefore charge-discharge efficiency is deteriorated.

The area ratio of the negative electrode active material in the vicinity of such an interface cannot be controlled only by the mixing ratio between the negative electrode active material and the solid electrolyte. The area ratio of the negative electrode active material in the vicinity of the interface varies depending on the susceptibility of the solid electrolyte to destroy and the mixing method in addition to the mixing ratio between the negative electrode active material and the solid electrolyte. For example, according to investigations of the present inventors, it was verified that when the mixing ratio between the negative electrode active material and the solid electrolyte is set to a weight ratio of 1:1, the area ratio of the negative electrode active material varies within the range of 43 to 77% in the vicinity of the surface of the formed body of the negative electrode mixture composed of the mixture, that is, in the vicinity of the interface between the current collector layer 14 and the negative electrode layer 12.

When the formed body of the negative electrode mixture is prepared by using a mixing method or a material in which the solid electrolyte is more easily destroyed than the negative electrode active material, since particles of the solid electrolyte are destroyed prior to particles of the negative electrode active material and fill in gaps between the particles of the negative electrode active material and therefore many particles of the solid electrolyte exist around the surface of the particle of the negative electrode active material, the area ratio of the negative electrode active material is reduced in the vicinity of the surface of the formed body. That is, a path of electron conduction is appropriately controlled by the particles of the solid electrolyte.

On the other hand, when the formed body of the negative electrode mixture is prepared by using a mixing method or a material in which the negative electrode active material is more easily destroyed than the solid electrolyte, fine particles of the negative electrode active material remain in the surface of the formed body, or fine particles of the negative electrode active material are agglomerated and tends to be exposed to the surface of the formed body, and therefore the area ratio of the negative electrode active material is increased in the vicinity of the surface of the formed body.

In addition, it was found that the area ratio of the negative electrode active material in the vicinity of the surface of the formed body of the negative electrode mixture varies depending on the mixing ratio of the negative electrode active material, the susceptibility of the solid electrolyte to destroy or the mixing method; however, the area ratio of the negative electrode active material cannot be controlled by a single factor and can be appropriately controlled in the vicinity of the surface of the formed body of the negative electrode mixture by combining a plurality of factors.

The negative electrode active material is preferably a carbon material. A battery having a high capacity is obtained by using the carbon material as the negative electrode active material.

Further, with respect to the solid electrolyte, a formed body obtained by press forming at a pressure of 365 MPa preferably has a relative density of 0.9 or more. Even when the mixing ratio (weight ratio) between the negative electrode active material and the solid electrolyte for respectively forming the negative electrode layer 12 is the same, the area ratio of the negative electrode active material in the surface of the formed body constituting the negative electrode layer 12 varies depending on the properties of the solid electrolyte. When the solid electrolyte, in which a formed body obtained by press forming at a pressure of 365 MPa has a relative density of 0.9 or more, is used, since the solid electrolyte is relatively easily destroyed, the area ratio of the negative electrode active material can be reduced in the vicinity of the surface of the formed body of the negative electrode mixture and a state, in which the negative electrode active material is appropriately dispersed, can be caused even when a mixing ratio of the negative electrode active material is large.

Particles composing the negative electrode active material preferably have a particle size ratio (D10/D90) of 0.5 or more. The negative electrode active material, in which particles composing the negative electrode active material has a particle size ratio (D10/D90) of 0.5 or more, is in a state in which the negative electrode active material is not destroyed, and thereby, the area ratio of the negative electrode active material can be reduced in the vicinity of the surface of the formed body of the negative electrode mixture, and the failure during charge due to precipitation of lithium metal hardly occurs. Moreover, even when the mixing ratio of the negative electrode active material is relatively large, energy density of the negative electrode can be increased since the area ratio of the negative electrode active material is reduced in the surface of the negative electrode layer.

The positive electrode layer 11 contains, for example, Li₂FeS₂ etc. as a positive electrode active material, and a mixture of Li₂S and P₂S₅, etc., which is an ion-conductive compound, as a solid electrolyte. The negative electrode layer 12 contains, for example, a carbon material such as spherical graphite as a negative electrode active material, and a mixture of Li₂S and P₂S₅, etc., which is an ion-conductive compound, as a solid electrolyte. The solid electrolyte layer 13 sandwiched between the positive electrode layer 11 and the negative electrode layer 12 contains, for example, a mixture of Li₂S and P₂S₅, etc., which is an ion-conductive compound, as a solid electrolyte. The positive electrode layer 11, the negative electrode layer 12 and the solid electrolyte layer 13 are each prepared by compression-molding a raw material. The solid electrolyte should contain at least lithium and sulfur as constituent elements, and examples of such a compound may include a mixture of Li₂S and B₂S₃ in addition to a mixture of Li₂S and P₂S₅. The solid electrolyte should preferably further contain phosphorus in addition to lithium and sulfur as constituent elements, and examples of such a compound may include Li₇P₃S₁₁, Li₃PS₄ and compounds with their anions partially substituted with oxygen, in addition to a mixture of Li₂S and P₂S₅. The composition ratio of elements that form the solid electrolyte is not limited to the above-described ratios. The positive electrode active material should contain lithium, iron and sulfur as constituent elements, and examples of such a compound may include compounds such as Li_{2.33}Fe_{0.67}S₂ in addition to Li₂FeS₂.

Further, examples of other positive electrode active materials may include compounds such as lithium titanium sulfide and lithium vanadium sulfide. The composition ratio of elements that form the positive electrode active material is not limited to the above-described ratios.

The all-solid battery laminate 10 of the present invention may be used while the battery element shown in the Figure is inserted in, for example, a container made of ceramic, or used independently as in the form shown in the Figure.

Next, examples of the present invention will be described in detail. Examples shown below are illustrative, and the present invention is not limited to the examples described below.

### EXAMPLES

Hereinafter, Examples 1 to 3 and Comparative Examples 1 to 4, in which all-solid batteries were respectively prepared by changing the area ratio of the negative electrode active material in the vicinity of the surface of the formed body of the negative electrode mixture for forming the negative electrode layer, will be described.

### Example 1

<Preparation of Solid Electrolyte>

A solid electrolyte was prepared by treating a Li₂S powder and a P₂S₅ powder which were respectively a sulfide by mechanical milling.

Specifically, in an atmosphere of an argon gas, a Li₂S powder and a P₂S₅ powder were weighed so as to have a molar ratio of 7:3, and mixed to prepare 1 g of a mixture. The prepared mixture was put in an alumina container, further alumina balls with a diameter of 10 mm were put in the container, and the container was made airtight. The container was set in a mechanical milling apparatus (planetary ball mill manufactured by Fritsch, model number P-7), and subjected to mechanical milling at 25° C. for 20 hours at a rotational speed of 370 rpm. The resulting whitish yellow glass powder was put in an airtight container made of glass and heated at 200° C. for 2 hours to obtain sulfide-based glass ceramic powder as a solid electrolyte.

In order to verify the susceptibility of the obtained solid electrolyte to destroy, a relative density (=density of a formed body/true density determined by a pycnometer method) of a formed body, which was obtained by press forming at a pressure of 365 MPa, was measured, and consequently the relative density was 0.92. “The density of a formed body” determined herein was calculated from a weight and a volume at the time when the solid electrolyte was formed into pellets with a diameter of 9.5 mm at a pressure of 365 MPa.

<Preparation of Positive Electrode Active Material>

A Li₂S powder and a FeS powder were weighed so as to have a molar ratio of 1:1, and mixed to prepare a mixture. The mixture was put in a quartz tube whose inner surface was coated with carbon, and vacuum-enclosed. Next, the quartz tube was heated at 950° C. for 5 hours to prepare Li₂FeS₂.

<Preparation of Positive Electrode Mixture>

The positive electrode active material and the solid electrolyte respectively obtained in the manner described above were mixed in proportions by weight of 1:1 to prepare a positive electrode mixture.

<Preparation of Negative Electrode Mixture>

The solid electrolyte obtained in the manner described above was preliminarily milled by a rocking mill. Conditions under which the agglomeration of the solid electrolyte can be pulverized were used. The reason why only the solid electrolyte is preliminarily milled is to mill the solid electrolyte without destroying the negative electrode active material. This acts to decrease the area ratio of the negative electrode active material in the vicinity of the surface of the formed body since the particles of the solid electrolyte fill in gaps between particles of the negative electrode active material without agglomerating at the time of forming in a subsequent step.

A spherical graphite (manufactured by Nippon Power Graphite Co., Ltd., trade name GDS-15-1, D50=19 μm) was used as the negative electrode active material. The negative electrode active material and the solid electrolyte preliminarily milled were mixed for 6 hours in proportions by weight of 1:1 by using a rocking mill (60 Hz) to prepare a negative electrode mixture.

<Preparation of All-Solid Battery>

150 mg of the solid electrolyte obtained in the manner described above was put in a die with an inner diameter of 10 mm, 15 mg of the positive electrode mixture was added to one surface of the solid electrolyte layer and 10 mg of the negative electrode mixture was added to the other surface of the solid electrolyte layer, and then both surfaces were pressed at a pressure of 330 MPa to prepare a laminate. Current collector layers made of a gold foil were formed on both surfaces of the laminate to prepare an all-solid battery laminate. The all-solid battery laminate was enclosed in a ceramic package with electrodes extracted from the package to prepare an all-solid battery.

On the prepared all-solid battery, the area ratio of the negative electrode active material was measured in a surface opposite to the surface adjacent to the solid electrolyte layer of the negative electrode layer, that is, in an interface between the current collector layer and the negative electrode layer in the following manner.

First, the current collector layer was peeled off, and an exposed surface of the negative electrode layer was made smooth by dry-etching to avoid degradation of the negative electrode layer.

Next, the surface of the negative electrode layer was photographed by using a scanning electron microscope (manufactured by ELIONIX INC., model number ERA-8900FE, acceleration voltage 10 kV, magnification 300×). Five fields selected at random in the surface of the negative electrode layer were photographed at an area of the field of view of 300 μm×400 μm, and an intermediate-contrast image of the resulting five images was employed.

Million pixels constituting the image were classified in 256 levels according to their lightness, and a histogram of the pixels was made. The resulting histogram has peaks in both of an area where lightness is relatively low (black) and an area where lightness is relatively high (white). The black area corresponds to an area where the negative electrode active material is present, and the white area corresponds to an area where the solid electrolyte is present. In the obtained histogram having two peaks, pixels were binarized taking the lightness of the pixel corresponding to a valley positioned between two peaks as a threshold level. Thereby, the area where the negative electrode active material is present is recognized as a pixel of black, and the area where the solid electrolyte is present is recognized as a pixel of white.

The area ratio of the negative electrode active material in the surface of the negative electrode layer (negative electrode active material area ratio) was calculated by the following equation based on the number of pixels of a negative electrode active material part (black) and a solid electrolyte part (white).

Negative electrode active material area ratio (%)=Number of pixels of negative electrode active material part/(Number of pixels of negative electrode active material part+Number of pixels of solid electrolyte part)×100

In addition, the image is taken at a contrast at which halation and blocked up shadows do not occur. If the solid electrolyte area looking white in observation by the scanning electron microscope causes halation (overexposure) or the negative electrode active material looking black in observation by the scanning electron microscope causes blocked up shadows, a boundary between the solid electrolyte and the negative electrode active material is not defined and an exact area cannot be determined.

When the halation and the blocked up shadows do not occur, the exact area can be determined without having a dependence on the contrast.

The ratio of the negative electrode active material thus measured was 57%.

Next, using the above image, a particle size of the negative electrode active material was measured in the following manner.

In the area recognized as an area where the negative electrode active material is present in the above image, particle diameters of particles of the negative electrode active material were measured. When the particle has an elliptic shape, the particle diameter was measured taking a minor axis of the particle as a particle diameter.

In the particle size distribution of the negative electrode active material measured as described above, D10 was 10 μm, D90 was 18 μm, and the particle size ratio (D10/D90) was 0.56.

A charge-discharge test of the prepared all-solid battery was conducted. In the charge-discharge test, first, the battery was charged at a charge current value of 3.82 mA/cm² up to a capacity of 100 mAh/g. Thereafter, the battery was discharged at a discharge current value of 0.13 mA/cm² to a cut-off voltage of 1 V, and a discharge capacity was measured. Charge-discharge efficiency (charge-discharge efficiency=discharge capacity/charge capacity) was determined from a ratio of the discharge capacity to the charge capacity, and consequently the charge-discharge efficiency was 97.9%, and a battery having extremely high charge-discharge efficiency was obtained.

As described above, it is found that when the area ratio of the negative electrode active material in the vicinity of the interface between the current collector layer and the negative electrode layer was reduced to 72% or less, a battery not causing the failure during charge was obtained.

### Example 2

A all-solid battery was prepared in the same manner as in Example 1 except for preparing a solid electrolyte in the following manner.

In an atmosphere of an argon gas, a Li₂S powder and a P₂S₅ powder were weighed so as to have a molar ratio of 8:2, and mixed to prepare 1 g of a mixture. The prepared mixture was put in an alumina container, further alumina balls with a diameter of 10 mm were put in the container, and the container was made airtight. The container was set in a mechanical milling apparatus (planetary ball mill manufactured by Fritsch, model number P-7), and subjected to mechanical milling at 25° C. for 20 hours at a rotational speed of 370 rpm. The resulting whitish yellow glass powder was put in an airtight container made of glass and heated at 300° C. for 2 hours to obtain sulfide-based glass ceramic powder as a solid electrolyte.

The area ratio of the negative electrode active material was measured in the same manner as in Example 1. The ratio of the negative electrode active material was 43%.

The particle size distribution of the negative electrode active material was measured in the same manner as in Example 1. In the particle size distribution of the negative electrode active material, D10 was 10 μm, D90 was 19 μm, and the particle size ratio (D10/D90) was 0.53.

A charge-discharge test of the prepared all-solid battery was conducted in the same manner as in Example 1. The charge-discharge efficiency was 86.1%, and a battery having high charge-discharge efficiency was obtained.

### Example 3

A all-solid battery was prepared in the same manner as in Example 1 except for preparing a negative electrode mixture in the following manner.

The negative electrode active material and the solid electrolyte were mixed for 5 minutes in proportions by weight of 1:1 by using a rocking mill (60 Hz) including balls to prepare a negative electrode mixture.

The area ratio of the negative electrode active material was measured in the same manner as in Example 1. The ratio of the negative electrode active material was 72%.

The particle size distribution of the negative electrode active material was measured in the same manner as in Example 1. In the particle size distribution of the negative electrode active material, D10 was 10 μm, D90 was 16 μm, and the particle size ratio (D10/D90) was 0.50.

A charge-discharge test of the prepared all-solid battery was conducted in the same manner as in Example 1. The charge-discharge efficiency was 96.6%, and a battery having extremely high charge-discharge efficiency was obtained.

### Comparative Example 1

A all-solid battery was prepared in the same manner as in Example 2 except for preparing a negative electrode mixture in the following manner.

The negative electrode active material and the solid electrolyte were mixed for 5 minutes in proportions by weight of 1:1 by using a rocking mill (60 Hz) including balls to prepare a negative electrode mixture.

The area ratio of the negative electrode active material was measured in the same manner as in Example 1. The ratio of the negative electrode active material was 77%.

The particle size distribution of the negative electrode active material was measured in the same manner as in Example 1. In the particle size distribution of the negative electrode active material, D10 was 6 μm, D90 was 20 μm, and the particle size ratio (D10/D90) was 0.30.

It is found that in Comparative Example 1, since the particle size ratio (D10/D90) of the negative electrode active material is smaller than those of Examples 1 to 3 and pulverization of particles of the negative electrode active material proceeds, the area ratio of the negative electrode active material becomes large.

A charge-discharge test of the prepared all-solid battery was conducted in the same manner as in Example 1. The charge-discharge efficiency was 73.8%, and a battery having low charge-discharge efficiency was obtained.

### Comparative Examples 2 to 4

All-solid batteries were prepared in the same manner as in Example 2 except for preparing a negative electrode mixture and a laminate in the following manner.

The negative electrode active material and the solid electrolyte were mixed for 5 minutes in proportions by weight of 6:4 (Comparative Example 2), 7:3 (Comparative Example 3) and 8:2 (Comparative Example 4), respectively, by using a rocking mill (60 Hz) including balls to prepare negative electrode mixtures of Comparative Examples 2 to 4.

150 mg of the solid electrolyte obtained in the manner described above was put in a die with an inner diameter of 10 mm, and 15 mg of the positive electrode mixture was added to one surface of the solid electrolyte layer, and 7.1 mg (Comparative Example 2), 6.3 mg (Comparative Example 3) and 5.6 mg (Comparative Example 4) of the negative electrode mixtures were respectively added to the other surface of the solid electrolyte layer, and then both surfaces were pressed at a pressure of 330 MPa to prepare laminates of Comparative Examples 2 to 4.

The area ratio of the negative electrode active material was measured in the same manner as in Example 1. The ratio of the negative electrode active material was 82% in Comparative Example 2, 84% in Comparative Example 3, and 91% in Comparative Example 4.

A charge-discharge test of the prepared all-solid battery was conducted in the same manner as in Example 1. In Comparative Example 2, the charge-discharge efficiency was 60.8%, and a battery having low charge-discharge efficiency was obtained. The all-solid batteries of Comparative Example 3 and Comparative Example 4 caused a short circuit and did not operate as a battery.

The above results are shown in Table 1.

TABLE 1

| | Area Ratio of Negative Electrode | Charge-Discharge |
|---|---|---|
| | Active Material [%] | Efficiency [%] |
| Example 1 | 57 | 97.9 |
| Example 2 | 43 | 86.1 |
| Example 3 | 72 | 96.6 |
| Comparative | 77 | 73.8 |
| Example 1 | | |
| Comparative | 82 | 60.8 |
| Example 2 | | |
| Comparative | 84 | — |
| Example 3 | | |
| Comparative | 91 | — |
| Example 4 | | |

It should be considered that the embodiments and examples disclosed herein are for illustrative purposes in all respects, and not limiting. The scope of the present invention is shown by the claims, not by the above embodiments and examples, and intended to include all modifications and variations in meaning and scope equivalent to the claims.

An all-solid battery having high charge-discharge efficiency can be obtained by the present invention.

### DESCRIPTION OF REFERENCE SYMBOLS

10: All-solid battery

11: Positive electrode layer

12: Negative electrode layer

13: Solid electrolyte layer

14: Current collector layer

1. An all-solid battery comprising:
a positive electrode layer;
a negative electrode layer, the negative electrode layer containing a negative electrode active material and a solid electrolyte; and
a solid electrolyte layer interposed between the positive electrode layer and the negative electrode layer,
wherein an area ratio of the negative electrode active material is 72% or less in a surface of the negative electrode layer opposite to a solid electrolyte-side surface of the negative electrode layer.

2. The all-solid battery according to claim 1, wherein the negative electrode active material is a carbon material.

3. The all-solid battery according to claim 2, wherein the carbon material is spherical graphite.

4. The all-solid battery according to claim 2, wherein the solid electrolyte contains Li₂S and P₂S₅.

5. The all-solid battery according to claim 1, wherein the solid electrolyte contains Li₂S and P₂S₅.

6. The all-solid battery according to claim 1, wherein the solid electrolyte is a formed body having a relative density of 0.9 or more.

7. The all-solid battery according to claim 1, wherein the negative electrode active material has a particle size ratio (D10/D90) of 0.5 or more.

8. The all-solid battery according to claim 1, wherein the positive electrode layer contains a positive electrode active material and the solid electrolyte.

9. The all-solid battery according to claim 8, wherein the positive electrode active material is Li₂FeS₂ etc., negative electrode active material is a carbon material, and the solid electrolyte contains Li₂S and P₂S₅.
